(19) United States
(12) Patent Application Publication
(10) Pub. No.: US 2026/0244996 A1
(43) Pub. Date: Aug. 20, 2026

(54) EFFICIENTLY UPDATABLE MACHINE LEARNING

(71) Applicant: INTERNATIONAL BUSINESS MACHINES CORPORATION, Armonk, NY (US)

(72) Inventors: Swanand Ravindra Kadhe, San Jose, CA (US); Ambrish Rawat, Dublin (IE); Nathalie Baracaldo Angel, San Jose, CA (US)

(21) Appl. No.: 19/058,678

(22) Filed: Feb. 20, 2025

(51) Int. Cl. G06N 20/20

(52) U.S. Cl. CPC G06N 20/20

(57) ABSTRACT

A method of generating machine learning predictions by an efficiently updatable ensemble of machine learning models includes identifying, in response to an inference request, one or more machine learning models of the ensemble that are available for generating a prediction. An aggregated prediction is generated in response to the inference request. The aggregated prediction aggregates individual predictions generated by the one or more machine leaning models of the ensemble identified as available to generate a prediction. Responsive to determining that less than all of the ensemble of machine learning models are available, a performance guarantee based on the individual predictions is generated. The aggregated prediction is output in response to the performance guarantee satisfying a predetermined threshold.

### BACKGROUND

This disclosure relates to machine learning and, more particularly, to implementing an updatable ensemble of machine learning models capable of generating predictions while simultaneously undergoing model updates.

Foundation models of various types are increasingly used for handling a wide variety of tasks. A foundation model can be designed to perform tasks such as understanding diverse languages, generating text and images, and conversing in a natural language. Different types of foundation models integrate different types of machine learning techniques. Foundation models may be implemented as large neural networks and may incorporate such machine learning techniques as transformers, variational encoders, generative adversarial networks, transfer learning, and self-supervised learning, as well as other machine learning techniques. A uniform characteristic of most if not all foundation models, however, is that such models are typically trained using very large collections or corpora of training data.

### SUMMARY

In one or more embodiments, a method of generating machine learning predictions by an updatable ensemble of machine learning models includes identifying, in response to an inference request, machine learning models of the ensemble that are available for generating a prediction. An aggregated prediction is generated in response to the inference request. The aggregated prediction aggregates individual predictions generated by the machine learning models of the ensemble identified as available to generate a prediction. Responsive to determining that less than all of the ensemble of machine learning models are available, a performance guarantee based on the individual predictions is generated. The aggregated prediction is output in response to the performance guarantee satisfying a predetermined threshold.

In one or more embodiments, a system includes one or more processors configured to initiate executable operations as described within this disclosure.

In one or more embodiments, a computer program product includes one or more computer-readable storage media and program instructions collectively stored on the one or more computer-readable storage media. The program instructions are executable by a processor to cause the processor to initiate operations as described within this disclosure.

This Summary section is provided merely to introduce certain concepts and not to identify any key or essential features of the claimed subject matter. Many other features and embodiments of the invention will be apparent from the accompanying drawings and from the following detailed description.

### BRIEF DESCRIPTION OF THE DRAWINGS

The accompanying drawings show one or more embodiments; however, the accompanying drawings should not be taken to limit the invention to only the embodiments shown. Various aspects and advantages will become apparent upon review of the following detailed description and upon reference to the drawings.

FIG. 1 illustrates an example of a computing environment that is capable of implementing an updatable machine learning (UML) framework.

FIG. 2 illustrates an example architecture of the UML framework.

FIG. 3 illustrates an example method of operation of the UML framework of FIG. 2.

FIG. 4 illustrates an example of generating an aggregated prediction by UML framework of FIG. 2

FIG. 5 illustrates an example method of operation for generating a performance guarantee by UML framework of FIG. 2.

FIG. 6 illustrates another example method of operation for generating a performance guarantee by UML framework of FIG. 2.

FIGS. 7A and 7B illustrate the sharding or partitioning of a collection or corpus of training data into distinct shards or datasets by UML framework of FIG. 2.

FIGS. 8A and 8B illustrate, respectively, training an ensemble of machine learning models by the UML framework of FIG. 2 and subsequently updating one or more machine learning models of an ensemble by the UML framework of FIG. 2.

FIG. 9 illustrates an example method of operation for training an ensemble of machine learning models by the UML framework of FIG. 2.

FIG. 10 illustrates an example method of operation for updating one or more machine learning models of an ensemble of machine learning models by the UML framework of FIG. 2.

### DETAILED DESCRIPTION

While this disclosure concludes with claims defining novel features, it is believed that the various features described herein will be better understood from consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to machine learning and, more particularly, to implementing an updatable ensemble of machine learning models capable of generating predictions while simultaneously undergoing model updates. In certain embodiments, the inventive arrangements disclosed herein operate as foundation model as a service (FMaaS). Notwithstanding the power and versatility of foundation models, the fact that virtually all such models are trained using very large corpora presents several challenges. For example, not only is it often costly to train a foundation model, but after deployment at some point, it may be necessary to retrain the model.

Retraining may be necessary for several reasons. Given that a foundation model may include data “crawled” from the Internet or a publicly available dataset, it may be necessary to retrain the foundation model after excising personally identifiable information (PII). Similarly, if the model were trained using data that proved to be proprietary, then absent obtaining a license to use the data, the model may need to be retrained without the proprietary data. The model may need to be retrained, for example, if the initial dataset included poisoned samples intended to introduce Trojans or backdoors into the model. Although data inspection and sanitization may mitigate these problems, the sheer size of a typical dataset used to train a foundation model makes it extremely challenging to thoroughly inspect and sanitize every dataset sample. Moreover, with many foundation models, retraining may be necessary to maintain or enhance the power of the model.

In accordance with the inventive arrangements described herein, methods, systems, and computer program products are provided that are capable of generating an aggregated machine learning model prediction in response to an inference request, the aggregated prediction generated by aggregating individual predictions generated by machine learning models forming at least part of an ensemble of machine learning models. The ensemble comprises multiple machine learning models configured to operate cooperatively in implementing one or more ensemble learning techniques. Individual predictions generated by each machine learning model of the ensemble are aggregated in accordance with an ensemble learning technique to generate an aggregated prediction that is likely more accurate than each individual prediction alone. In certain embodiments, members of the ensemble may be trained with different algorithms, increasing the likelihood that not all the members make the same errors, thus increasing the predictive accuracy of the ensemble of machine learning models. If less than all the machine learning models of the ensemble are available to generate individual predictions, then a performance guarantee is generated. The performance guarantee indicates how close the aggregated prediction generated based on individual predictions generated by the available machine learning models is likely to be to one generated based on individual predictions generated by all the machine learning models of the ensemble.

The ability to generate aggregated predictions with less than the entire complement of machine learning models forming the ensemble enables efficient updating of individual machine learning models without interruption to the ability to generate the aggregated predictions. In certain embodiments, the inventive arrangements implement an FMaaS. As an FMaaS, the ensemble of machine learning models substitutes for a monolithic foundation model. Like a conventional foundation model, the ensemble may be trained on a large collection or corpus of training data. But unlike with a conventional foundation model, the large collection or corpus of training data may be split or partitioned into smaller, distinct datasets and each distinct dataset may then train one of the machine learning models of the ensemble.

The ability to separately train each machine learning model of the ensemble with one of the distinct datasets created by partitioning a large collection or corpus of training data provides unique technical advantages. One technical advantage is the ability to provide the FMaaS without interruption even when it is necessary to update the collection or corpus of training data by, for example, removing certain data samples. With a conventional foundation model, any update of the training data on which the model has been trained typically requires retraining the entire model. During the retraining, the services provided by the foundation model are interrupted. By contrast, with the inventive arrangements disclosed herein, only the split or partitioned dataset(s) that contain the data samples need be updated. While the machine learning models trained on datasets containing the data samples are being retained on updated datasets, other machine learning models of the ensemble remain available to continue operating as an FMaaS uninterrupted.

Another technical advantage arising from the splitting or partitioning of the large collection or corpus of training data is that the update time of retraining a machine learning of the ensemble is likely shorter given that the split or partitioned dataset used in training the model is smaller than the larger collection or corpus from which the dataset is culled. Although reducing the amount of training data may reduce the accuracy of predictions generated by a machine learning model, this effect is offset by the fact that with the inventive arrangements the predictions generated are aggregations of individual predictions generated by multiple machine learning models of an ensemble. Various ensemble methods described herein (e.g., majority voting, model averaging) may be used to aggregate the individual predictions. Aggregating predictions using the various ensemble methods improves the accuracy of the aggregated prediction based on multiple, individual predictions. For example, given that different models are unlikely to make the same errors, model averaging tends to enhance the predictive accuracy of an ensemble of machine learning models, which is an additional technical advantage. Moreover, certain aspects of the inventive arrangements include fine tuning the machine learning using not one but two hyperparameters, namely accuracy and update time, and setting the separate hyperparameters to achieve or approach an optimal trade-off between model accuracy and update efficiency.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the inventive arrangement are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

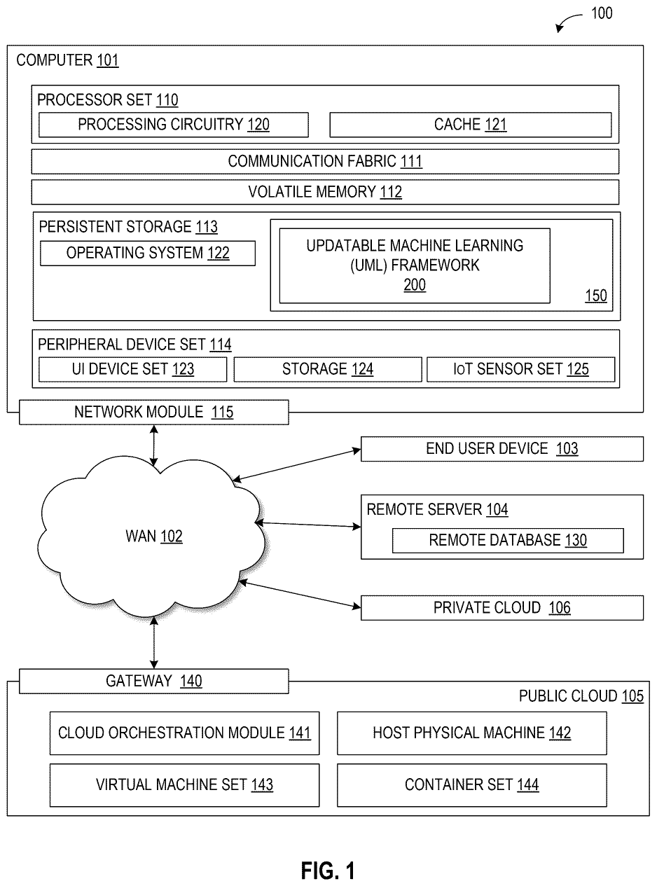

Referring to FIG. 1, computing environment 100 contains an example of an environment for the execution of at least some of the computer code illustrated at block 150 that is involved in performing the inventive methods disclosed herein. The inventive methods performed with the computer code of block 150 can include implementing an updatable machine learning (UML) framework 200.

UML framework 200 is capable of splitting or partitioning a large collection or corpus of training data into smaller, distinct datasets. Each dataset is used by UML framework 200 to separately train multiple machine learning models forming a machine learning model ensemble. If a user submits an inference request while any of the machine learning models of the ensemble is being retrained following a modification of a dataset, there is the high likelihood that other machine learning models of the ensemble remain available to generate individual predictions. UML framework 200, using any of various ensemble methods, aggregates the individual predictions generated by the available machine learning models to generate an aggregated prediction in response to the inference request. UML framework 200 also may generate a performance guarantee regarding the aggregated prediction using the procedures described herein.

In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

EUD 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

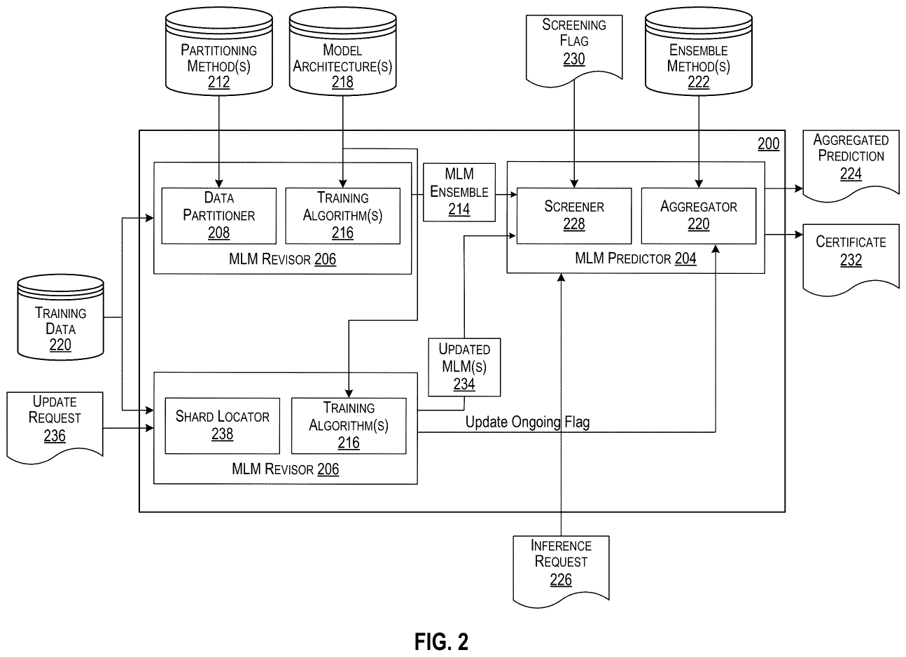

FIG. 2 illustrates an example architecture of UML framework 200. In the example architecture of FIG. 2, UML framework 200 illustratively includes machine learning model (MLM) ensemble trainer 202, MLM predictor 204, and MLM revisor 206. MLM ensemble trainer 202, MLM predictor 204, and MLM revisor 206 of UML framework 200, in certain embodiments, may be implemented with software executable on the hardware of computer 101 operating in computing environment 100.

MLM ensemble trainer 202 illustratively includes data partitioner 208, which shards or partitions a collection of training data 210 into multiple shards of training data or distinct datasets using one of partitioning methods 212. Each distinct dataset generated by data partitioner 208 is unique, though some data samples may be common to more than one dataset depending on partitioning method implemented. MLM ensemble trainer 202 generates an MLM ensemble 214 by executing training algorithms 216, which implement one or more model architectures 218, including for example a deep neural network, transformer, linear regression model, logistic regression model, decision tree learning model, support vector machine, k-nearest neighbor, or other MLM architecture. Each MLM of MLM ensemble 214 is uniquely trained on one of the multiple, distinct datasets generated by data partition 208. In one or more embodiments, at least one of the MLMs of MLM ensemble 214 may implement a machine learning architecture different than that implemented by other MLMs of the ensemble.

MLM predictor 204 illustratively includes aggregator 220 that, by implementing one of ensemble methods 222 described herein, generates aggregated prediction 224 by aggregating individual predictions of MLM ensemble 214 in response to inference request 226 submitted by a user. MLM predictor 204 additionally may include screener 228, which operates in response to detecting screening flag 230, a logic variable that when TRUE signals a user command to screen aggregated prediction 224 for accuracy. In response to the screening, MLM predictor 204 generates certificate 232, which is output to the user, and which indicates a performance guarantee corresponding to aggregated prediction 224. If aggregated prediction 224 is a classification (e.g., label), then the performance guarantee is a binary measure that indicates whether the difference between the largest count of available MLMs of MLM ensemble 214 predicting the same classification minus the next-largest count of MLMs of MLM ensemble 214 predicting an alternative classification exceeds the number of impacted MLMs. As used herein, “available MLM” means that the MLM of an ensemble is available for generating a prediction that may be used for generating the aggregated prediction 224. Conversely, “impacted MLM” means that the MLM is not currently available for generating a prediction because the MLM is in the process of being revised by MLM revisor 206. If aggregated prediction 224 is a regression in which a scalar or vector of discrete values is generated in response to inference request 226, then the performance guarantee, computed as described in detail below, provides an upper and lower bound within which the prediction or estimate is lies and establishes (in a probabilistic sense) that, even in the worst case, the estimate is within a threshold percentage of an estimate that would be generated were all the MLMs of MLM ensemble available to contribute predictions for generating aggregated prediction 224. As also described below, the user may set the threshold percentage.

MLM revisor 206 revises each impacted MLM of MLM ensemble 214. An MLM of MLM ensemble 214 is impacted whenever the MLM is undergoing retraining because of modifying the distinct dataset on which the MLM was previously trained. The dataset may be modified by removing old data samples and/or adding new data samples. MLM revisor 206 may generate one or more updated MLMs 234 using the same training algorithm(s) 216 previously used to train each of the MLMs albeit on a now-modified dataset. Retraining may be necessitated by update request 236 requesting that certain data samples (e.g., proprietary or personal data samples) be excised from training data 210. Because training data 210 was sharded or partitioned into discrete datasets, however, it is likely that some of the datasets do not contain data subject to update request 236. Shard locator 238 identifies each dataset that does, the identification based on a unique identifier (e.g., hash tag) assigned to each dataset generated by data partitioner 208 and identifying the particular MLM trained using a specific dataset. Each such MLM is an impacted MLM while it is undergoing retraining by MLM revisor 206.

In certain embodiments, UML framework 200 implements a foundation model as a service (FMaaS). As an FMaaS, UML framework 200 may utilize network module 115 to communicatively couple via WAN 102 (e.g., Internet) with various users operating end user devices such as user device 103, one or more remote servers such as remote server 104, and/or other systems, including ones operating on public cloud 105 and/or private cloud 106. UML framework 200 as an FMaaS, for example, is capable of generating predictions (e.g., regressions, classifications) in response to users'inference requests, the predictions generated by one or more MLMs forming all or part of a MLM ensemble 214 trained by MLM ensemble trainer 202.

With a conventional FMaaS the underlying model is monolithic. Accordingly, even a slight modification of the data used to train the model likely may necessitate retraining the entire model. If so, then the servicing of inference requests must be suspended while the model undergoes retraining. Moreover, given the size of the model, retraining may take a considerable period of time.

An aspect of UML framework 200's using an ensemble of multiple MLMs to generate predictions—in contrast to using a monolithic foundation model—is that it is likely that predictions may be generated without interruption even if some of the MLMs of MLM ensemble 214 are undergoing retraining. That is, UML framework 200 may continue to provide predictions uninterrupted while one or more of the MLMs of MLM ensemble 214 are undergoing retraining. Retraining may be necessary, for example, because one or some of the MLMs of MLM ensemble 214 were previously trained using data samples that must now be excised and the MLM(s) retrained using a modified set of data that does not include the specific data samples excised from the earlier set of data. In other scenarios, it may be necessary to retrain one or more of the MLMs of MLM ensemble 214 using an updated set of training data that includes newly acquired data to ensure the MLM(s) continue to generate reliable predictions. In still other scenarios it may be necessary to retrain one or more of the MLMs of MLM ensemble 214 using an updated set from which some prior data has been removed and newer data added.

In various embodiments, UML framework 200 may implement different techniques for selecting one or more MLMs for updating. The different techniques may provide certain advantages. For example, in certain embodiments, if one or more MLMs are trained on smaller sized subsets of data, then additional data samples may be added to update the MLMs (especially, the one trained on the smallest subset). Adding samples to the smallest subset results in less training time. The samples in some embodiments, for example, may be added to update the MLM that has undergone the least number of updates. Adding samples to the MLM that has undergone the least number of updates result in ‘load balancing’across MLMs in terms of updates.

Regardless of the reason for retraining, unless all of the MLMs of MLM ensemble 214 must be retrained simultaneously—an unlikely event—the remaining MLMs are available to generate predictions in response to user inference requests uninterrupted. As described in detail below, UML framework 200 is further capable of outputting certificate 232 certifying certain aspects of aggregated prediction 224, even if generated by less than all the MLMs of MLM ensemble 214. If aggregated prediction 224 is a classification, then the certification may be that the classification would not likely be different even were it generated with all the MLMs available. If aggregated prediction 224 is a regression, then the certification may be that prediction is within a specified percentage of an aggregated prediction generated by aggregating individual predictions generated by all the MLMs of MLM ensemble 214.

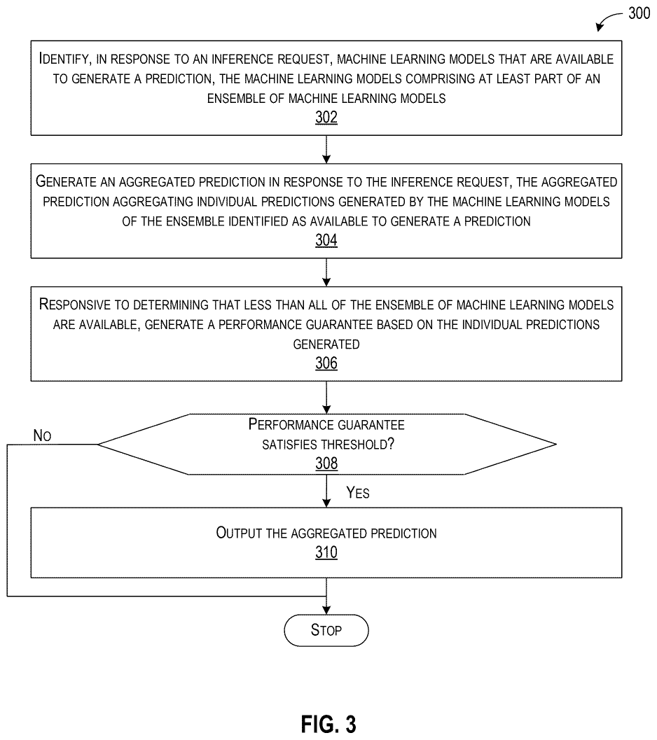

FIG. 3 illustrates an example method 300 of operation of UML framework 200 of FIG. 2 in generating predictions in response to inference requests from users. A prediction responsive to a user inference request is generated by MLM predictor 204 using one or more MLMs forming MLM ensemble 214 trained by MLM ensemble trainer 202.

Referring to FIGS. 2 and 3 collectively, in block 302, aggregator 220 identifies certain MLMs of MLM ensemble 214 in response to inference request 226. Each of the MLMs identified are available to generate a prediction, even though one or more other MLMs of MLM ensemble 214 may be impacted by update request 236 and therefore currently undergoing retraining by MLM revisor 206. It may be that the requests are uncoordinated submissions by separate users whose only commonality is that their request submissions are sufficiently close in time to render some MLMs of MLM ensemble 214 available for responding to inference request 226 while one or more other of the MLMs is impacted by update request 236. In block 302, UML framework 200 also detects which MLMs are not available. The detecting may be based on a locator (described below) that provides a one-to-one correspondence between datasets and the models that each dataset is used to train. UML framework 200 thus identifies an unavailable MLM by detecting that the corresponding data used to train the MLM is currently undergoing an updating of data samples contained in the dataset (e.g., removal of certain data samples).

In block 304, aggregator 220 generates aggregated prediction 224 in response to the inference request 226. The aggregated prediction is generated by aggregator 220's implementing one of ensemble methods 222. Implementing the ensemble method selected, aggregator 220 aggregates individual predictions generated by the MLMs of MLM ensemble 214 that are identified as available for generating predictions in response to inference request 226.

Which of ensemble methods 222 is selected by aggregator 220 for implementation may vary depending on the nature of inference request, whether for example the request is for the classification of a user input, or a regression based on the user input. Inference request 226 may request classification or ranking of recent films from one to five stars, for example. Or, for example, inference request 226 may request classification of an online article as relating to current news, sports, or entertainment. In generating aggregated prediction 224 to classify a user input (e.g., film, article), aggregator 220 may use the ensemble method of majority voting according to which aggregated prediction 224 assigns the classification or labels predicted by the majority of available MLMs generating a prediction (classification or label).

Inference request 226, may be a request for a regression such as estimating based on the input of a feature vector the estimated price of housing in a certain geographical region, the estimated size of a tumor in an x-ray image, or the probability that a patient suffers from a specific disease. In such cases, the aggregated prediction 224 may be an average of the individual estimates generated by each of the available MLMs. With respect to both majority voting and scalar (or vector) estimation, aggregated prediction 224 may be based on weighting the individual predictions of the available MLMs. That is, the vote of one MLM may be weighted relatively more than that of another of the available MLM, or the estimate of one MLM may be weighted more than that of another available MLM.

The specific weighting applied may depend on various factors. For example, in some embodiments, weights may be assigned commensurate with the relative size of each distinct dataset an MLM was trained on, on the assumption that the larger the dataset size used to train the MLM, the more reliable the prediction generated by the MLM. In other embodiments, weights may reflect the complexity of the specific MLM generating an individual prediction. Such weighting reflects the fact that provided the available MLMs generate the same type of output (e.g., classification or regression), each available MLM may implement a different one of model architectures 218. If given the same prediction task, different model architectures have varied predetermined capacities for generating a correct prediction, then that fact may be reflected in weights assigned to each MLM's prediction based on the specific architecture implemented. Even if each of the available MLMs implements the same architecture using the same-sized datasets, the MLM's complexity may vary. For example, if one MLM implements a 1,000-parameter deep neural network while another implements a 20,000-parameter deep neural network, that difference itself may warrant weighting the prediction generated by the second deep neural network more than that of the first.

Referring still to FIGS. 2 and 3 collectively, in block 306, if less than all of MLMs of MLM ensemble 214 are identified as available, then MLM predictor 204 generates a performance guarantee. The performance guarantee indicates the confidence (in a probabilistic sense) that aggregated prediction 224 is correct. The performance guarantee may be based, in part, on individual predictions generated by the available MLMs.

In block 308, if the performance guarantee satisfies a predetermined threshold, then aggregated prediction 224 is output to the user in block 310. Otherwise, UML framework 200 abstains from providing any output. Optionally, if aggregated prediction 224 is output to the user, then certificate 232 may also be output along with aggregated prediction 224 to provide the user with a level of confidence in the result.

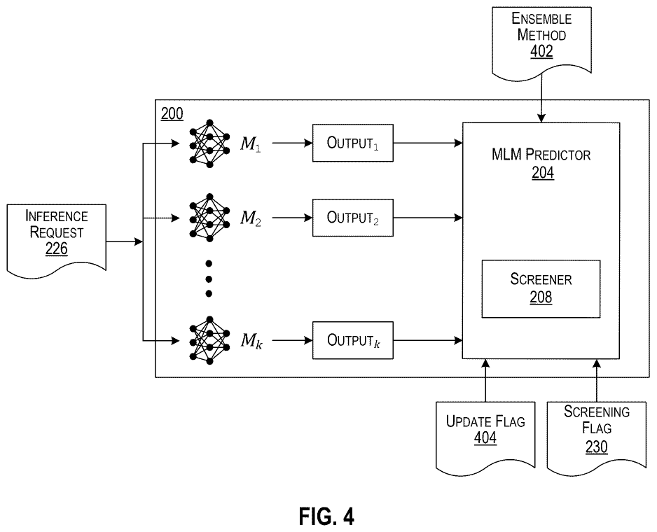

Referring to FIG. 4, in certain embodiments, UML framework 200 enables the user to choose whether to receive aggregated prediction 224 regardless of whether the entire complement of MLM ensemble 214 is available for generating aggregated prediction 224 in accordance with selected ensemble method 402 selected from among ensemble methods 222. Illustratively, UML framework 200 automatically sets update flag 404 to TRUE in response to update request 236, which requires modification of one or more distinct datasets and, accordingly, retraining of one or more MLMs of MLM ensemble 214. If update flag 404 is TRUE, then the user is provided the option to set screening flag 230 to TRUE. If screening flag 230 is not set by user, then aggregated prediction is output to the user regardless of whether the performance guarantee satisfies the predetermined threshold. In other embodiments, the user may elect to receive aggregated prediction 224 regardless of whether the performance guarantee satisfies the predetermined threshold and also have the option to request that certificate 232 be output along with the aggregated prediction. The performance guarantee depends on whether inference request 226 requests classification of an input or output of a regression based on the input. In one or more other examples, the user may be an end user, a system administrator, or person(s) in other roles.

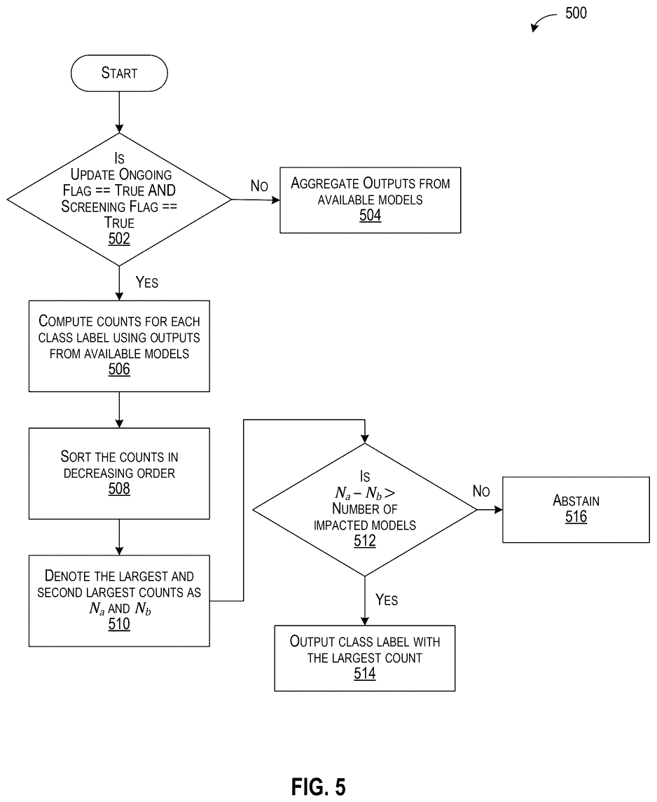

FIG. 5 illustrates example method 500 performed by UML framework 200 for generating a performance guarantee of aggregated prediction 224 when the aggregated prediction generated is the classification of a user input. The performance guarantee indicates whether aggregated prediction 224 is one likely generated based on individual predictions generated by all the machine learning models of the ensemble.

In block 502, UML framework 200 determines whether both update flag 404 is set to TRUE (indicating an ongoing update of one or more MLMs) and whether screening flag 230 is set to TRUE. If not, then at block 504 aggregator 220 of MLM predictor 204 aggregates the individual outputs of the MLM models identified as available. Aggregating the individual outputs in accordance with a selected one of ensemble methods 222, aggregator 220 generates aggregated prediction 224 for output without testing the prediction accuracy, that is without screening.

If, however, at block 502, the update and the screening flags are both set to TRUE, then at block 506 UML framework 200 computes the counts for each class label or category based on the individual outputs (classifications) of the available MLMs. In block 508, the counts are sorted in decreasing order by UML framework 200 and, at block 510, the largest and next-largest counts saved (e.g., stored in registers of computer 101). At block 512, UML framework 200 determines whether the performance guarantee satisfies a predetermined threshold. For a classification task, the performance guarantee is the difference between the classification having the highest count and the classification having the next-highest count. If the difference is greater than the number of impacted (unavailable) MLMs of MLM ensemble 214, then the threshold is satisfied, and at block 514, UML framework 200 outputs aggregated prediction, that is, the classification or label with the largest count. If the threshold is not satisfied—that is the difference is less than the number of impacted MLMs—then, because the user has opted for screening, UML framework 200 abstains at block 516 from outputting aggregated prediction 224.

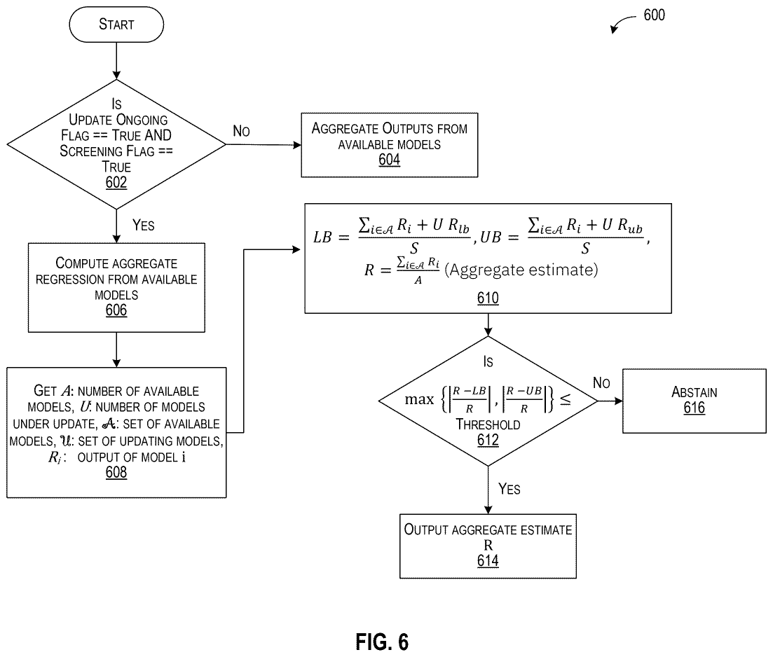

FIG. 6 illustrates example method 600 performed by UML framework 200 for generating a performance guarantee of aggregated prediction 224 when the aggregated prediction generated is a regression (e.g., point estimate of a scalar or n values of an n-element vector). The performance guarantee indicates whether the aggregated prediction is within a predetermined percentage of one generated based on individual predictions generated by all the machine learning models of MLM ensemble 214.

In block 602, UML framework 200 determines whether both update flag 404 is set to TRUE (indicating an ongoing update of one or more MLMs) and whether screening flag 230 is set to TRUE. If not, then at block 604 aggregator 220 of MLM predictor 204 aggregates the individual outputs of the MLM models identified as available, generating aggregated prediction 224 for output without screening the output by testing the accuracy of aggregated prediction 224.

If, however, at block 602, the update and the screening flags are both set to TRUE, then at block 606 UML framework 200 computes an aggregate regression generated by each of the available MLMs. UML framework 200, at block 608, determines the number of available MLMs, A, and the number of unavailable (impacted) MLMs, U, undergoing updating, with A and U representing the set of available and unavailable MLMs, respectively, and S is the number of MLMs. Training data 210 may be portioned into S or more subsets by partitioning the training data.

At block 610, UML framework 200 determines an aggregate estimate or regression, R, a lower bound, LB, and an upper bound, UB. R is the sum of individual regressions, Rᵢ, over the set of available MLMs, A, divided by the number of available MLMs, A. UML framework 200 computes LB by summing the individual regressions over the set of available MLMs, A, adding a lower bound regression R_{lb} (optionally, selected by the user or predetermined) multiplied by the number of unavailable MLMs, U, and taking a ratio of the sum over the number of distinct datasets S. UML framework 200 computes UB by summing the individual regressions over the set of available MLMs, A, adding an upper bound regression R_{ub} (optionally, selected by the user or predetermined) also multiplied by the number of unavailable MLMs, U, and taking a ratio of the sum over the number of distinct datasets S. At block 612, UML framework 200 computes a first ratio and second ratio. The first ratio is the difference between the aggregated prediction (estimate), R, and the lower bound, LB, divided the aggregated prediction, R. The second ratio is the difference between the aggregated prediction (estimate), R, and the upper bound, UB, divided by the aggregated prediction, R. The performance guarantee is the maximum of the two ratios. If the performance guarantee (the maximum ratio) is less than a predetermined percentage of an estimate generated with all the MLMs of MLM ensemble 214, then the threshold is satisfied, and aggregated prediction 224 (the aggregate regression or estimate R) is output to the user at block 614. Otherwise, UML framework 200 abstains from outputting aggregated prediction 224 in block 616 because the user has opted for screening.

In various embodiments, the predetermined percentage that serves as a threshold may correspond to a tolerance selected and set by the user. The larger the percentage, the greater the user's tolerance for deviating from the likely regression generated with all the MLMs available. Thus, the greater the percentage, the more accepting the user is of aggregated prediction 224 when based on aggregating individual predictions generated by less than the full complement of MLM ensemble 214.

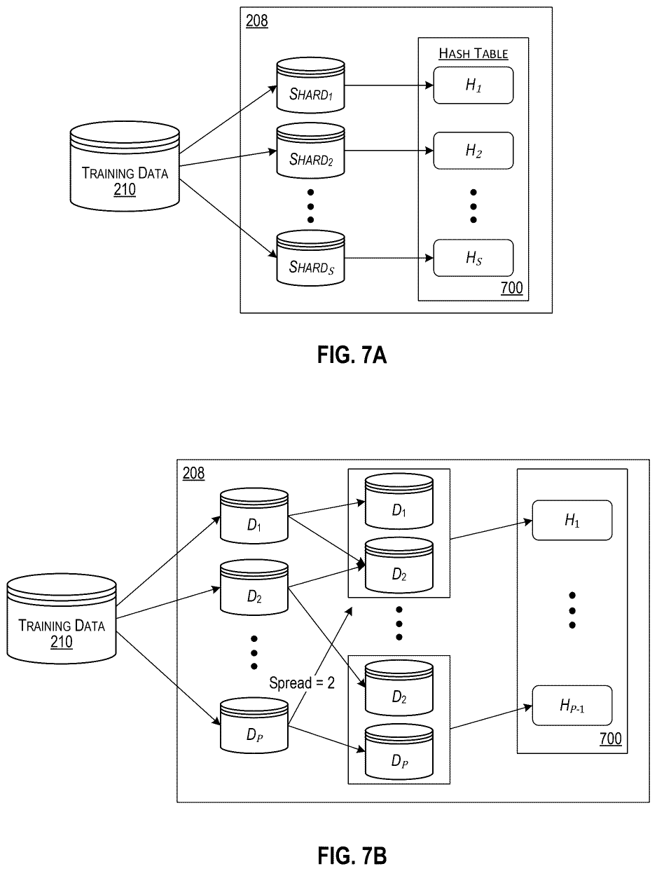

FIGS. 7A and 7B illustrate different embodiments, respectively, of data partitioner 208's partitioning training data 210, dividing the data into distinct datasets for training different MLMs of MLM ensemble 214. In FIG. 7A, data partitioner 208 partitions training data 210 by sharding the collection of training data into shards Shard₁ and Shard₂ through Shardₛ, where s is any positive integer belonging to set of integers S. Each of Shard₁ and Shard₂ through Shardₛ is a distinct dataset that may be used by MLM ensemble trainer 202 to train S MLMs to form MLM ensemble 214, comprising an S-member ensemble. Data partitioner 208 assigns to each distinct dataset formed by one of the S shards a unique locator. In certain embodiments, data partitioner 208 implements a hash function to generate hash table 700, which is data structure in which each of the elements H₁ and H₂ through Hₛ of the table has a one-to-one correspondence with Shard₁ and Shard₂ through Shardₛ, respectively. Implementing one or more training algorithms 216 corresponding to one or more model architectures 218, MLM ensemble trainer 202 may individually train each MLM of MLM ensemble 214 on one of the plurality of distinct datasets comprising shards Shard₁ and Shard₂ through Shardₛ. Thus, each dataset may be uniquely assigned for training a corresponding one of the S MLMs of the ensemble.

In another embodiment, illustrated in FIG. 7B, data partitioner 208 partitions training data 210 by partitioning the collection of training data 210 into individual datasets D₁ and D₂ through Dₚ, where p is any positive integer belonging to set of positive integers P. Illustratively, in FIG. 7B, data partitioner 208 performs an overlapping partitioning of the collection of training data. After initially partition training data 210 into P datasets, merges D₂ with the P-1 other datasets. Each overlapping partition is said to have a “spread” of two, given that each resulting dataset combines two datasets from the initial partitioning. Hash table 700 provides a one-to-one correspondence between the P-1 datasets and hash tags H₁ through Hₚ₋₁, each hash tag providing a unique locator that identifies the dataset on which a specific one of the MLMs of MLM ensemble 214 was trained.

The unique locators having a one-to-one correspondence between each MLM of MLM ensemble 214 and the dataset on which each is trained facilitate the individualized updating of the MLMs forming the ensemble. Using a hash table with the data samples acting as keys of the table and a hash such as SHA256 enables fast searches of the dataset records.

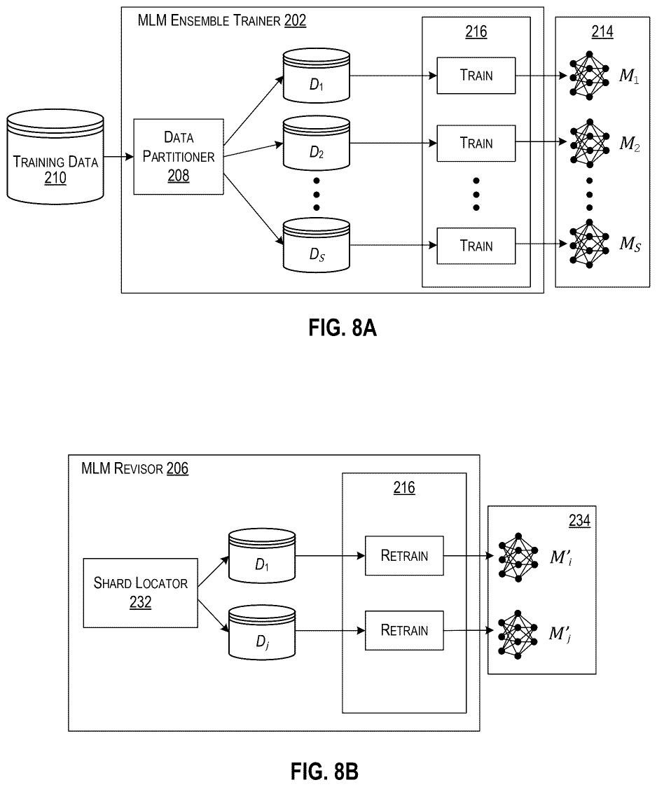

FIGS. 8A and 8B FIGS. illustrate, respectively, the training of MLM ensemble 214 by MLM ensemble trainer 202, and subsequently updating one or more MLMs of the ensemble by MLM revisor 206. In FIG. 8A, data partitioner 208 partitions training data 210 into distinct datasets D₁ and D₂ through Dₛ, where s is any positive integer. As already described, a unique locator or identifier is assigned to datasets D₁ and D₂ through Dₛ. Each unique locator assigned to a dataset may describe the data samples comprising the dataset and/or the source of the data samples. MLM ensemble trainer implements one or more of training algorithms 216 to train MLMs M₁ and M₂ through Mₛ that comprise MLM ensemble 214. The same locators that are each uniquely assigned to datasets D₁ and D₂ through Dₛ may likewise be uniquely assigned to MLMs M₁ and M₂ through Mₛ, respectively, which are trained on datasets D₁ and D₂ through Dₛ. The assignment thus also creates a one-to-one correspondence between datasets D₁ and D₂ through Dₛ and MLMs M₁ and M₂ through Mₛ, respectively.

As illustrated in FIG. 8B, the one-to-one correspondence between datasets D₁ and D₂ through Dₛ and MLMs M₁ and M₂ through Mₛ created by data partitioner 208's assigning the same unique locator to each MLM as that assigned to the dataset on which the MLM is trained facilitates the updating of individual MLMs of MLM ensemble 214. Illustratively, in FIG. 8B, shard locator 238 of MLM revisor 206 identifies Dᵢ and Dⱼ as datasets that must be updated in response to update request 236. For example, update request 236 may request that certain data samples be removed from among the data samples comprising training data 210 on which the MLMs of MLM ensemble 214 were trained after the partitioning of the data into discrete datasets. The update request may request removal of the data samples for any of the various reasons, including ones already described. Because the unique locator (e.g., hash tag) assigned to a dataset also may include or link to a description of the data samples comprising the dataset and/or the source of the data samples, shard locator 238 is able to identify datasets Dᵢ and Dⱼ as datasets that must be updated removing the specified data samples. In certain embodiments, the source or description of data samples serves as a unique locator. In other embodiments, the unique locator is a hash, such as SHA-2 hash, of the data samples. Using hash values, hash tables may be leveraged for efficient search of data samples to be modified. For example, if the training dataset consists of Wikipedia articles, then each article may be assigned a unique locator (e.g., SHA-256 hash of the article). When a certain article needs to be updated, then a search for the unique locator (e.g., SHA-256 hash) identifies which of the S subsets contains the article.

Datasets Dᵢ and Dⱼ optionally may be further modified by adding new data samples to substitute for the ones removed. The same locator used to identify datasets Dᵢ and Dⱼ also provides a one-to-one correspondence with the MLMs that were trained on datasets Dᵢ and Dⱼ prior to their updating. Once datasets Dᵢ and Dⱼ are updated, MLM revisor 206 implements the same or different training algorithms 216 to retrain the MLMs on the updated datasets. MLM revisor outputs updated MLMs 234, comprising MLMs M′ᵢ and M′ⱼ which are trained on updated datasets Dᵢ and Dⱼ, respectively.

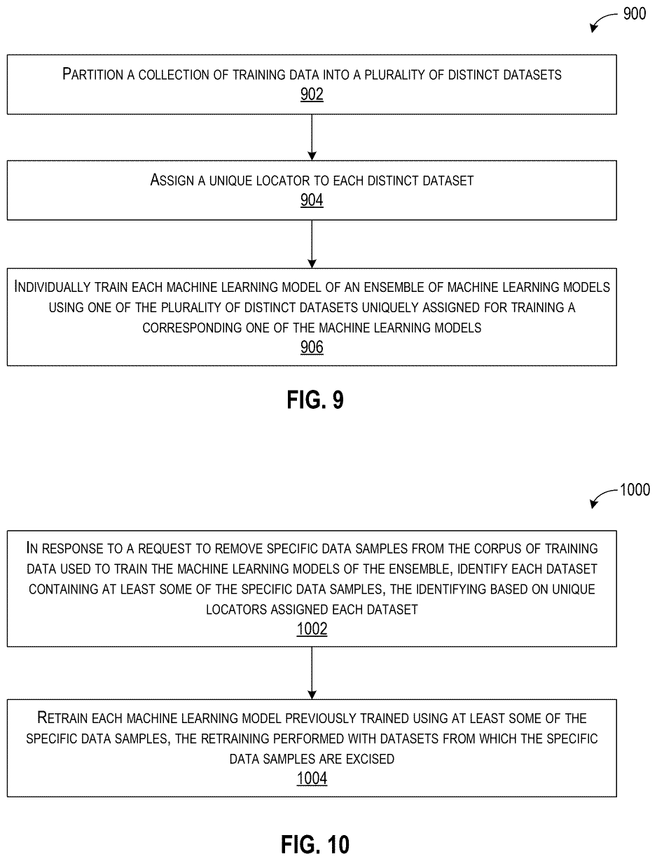

FIG. 9 illustrates an example method 900 of operation of UML framework 200 in training an ensemble of machine learning models. In block 902, UML framework 200 partitions the collection of training data 210 into a plurality of distinct datasets. In block 904, UML framework 200 assigns a unique locator to each of the plurality of distinct datasets. In block 906, UML framework 200 individually trains each machine learning model of the ensemble of machine learning models using one of the plurality of distinct datasets uniquely assigned for training a corresponding one of the machine learning models on the particular dataset.

FIG. 10 illustrates an example method 1000 of operation of UML framework 200 in updating one or more machine learning models of an ensemble of machine learning models. In block 1002, in response to a request to remove specific data samples from the corpus of training data used to train the machine learning models of an ensemble, UML framework 200 identifies each dataset containing at least some of the specific data samples. The identifying is based on unique locators (e.g., hash tags) assigned to each dataset. UML framework 200, in block 1004 retrains each machine learning model previously trained using at least some of the specific data samples. As described above, each locator uniquely assigned to each dataset created by portioning the corpus of training data may be uniquely assigned to the model trained by the dataset, thus providing a one-to-one correspondence between each dataset and each model trained on the dataset Models previously trained on datasets now modified by removal of the specific data samples are retrained on the same datasets, albeit with the specific data samples excised. Optionally, new data samples may be added to the datasets modified by removing the specific data samples, the newly added data samples offsetting the effects of removing other data samples from the datasets.

In general, the finer the partition of training data 210, the smaller each distinct data set is. MLMs trained on smaller datasets may be updated more rapidly than ones trained on larger datasets. But the smaller the dataset on which an MLM is trained, the less accurate the predictions generated by the MLM are likely to be, though the effect is offset at least to some extent by aggregating multiple predictions using an ensemble method, as described above. Nevertheless, there is thus a trade-off between accuracy and updating efficiency. In certain arrangements, the trade-off may be dealt with by tuning not one hyperparameter as conventionally done, but rather jointly fine tuning two hyperparameters. One hyperparameter is accuracy as measured by a selected scoring function. For regression MLMs, scoring functions include for example mean squared error (MSE), root mean squared error (RMSE), coefficient of determination (R-squared), and others. For classification MLMs, scoring functions include for example the proportion of correct classifications, the harmonic mean of the proportion of true positive predictions (F1 score), and others. With respect to fine tuning MLMs trained by UML framework 200, the second hyperparameter concerns the update time. There is no precise metric for update time apart from actual training of the MLM, but certain proxies may be used. One proxy, for example, is the number of samples included in the dataset. Another proxy, for example, is the number of training epochs.

An approximate optimization of the trade-off may be obtained by first determining the value of a selected scoring function for each validation or cross validation run using different combinations of the dual hyperparameters (scoring function thresholds and update times). Results for all feasible combinations or a randomly selected number of combinations of the hyperparameters may be generated. Once the results are generated, the approximate optimal trade-off is obtained by selecting the combination of hyperparameters (scoring function value and update time) that minimizes the update time while maintaining the value of the scoring function above a predetermined threshold. The threshold may be set by the user.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “one or more embodiments,” or similar language mean that a particular feature, structure, or characteristic described in connection with the embodiment is included in at least one embodiment described within this disclosure. Thus, appearances of the phrases “in one embodiment,” “in an embodiment,” “in one or more embodiments,” and similar language throughout this disclosure may, but do not necessarily, all refer to the same embodiment. The terms “embodiment” and “arrangement” are used interchangeably within this disclosure.

As defined herein, the term “processor” means at least one hardware circuit. The hardware circuit may be configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real-time” means a level of processing responsiveness that a user or system senses as sufficiently immediate for a particular process or determination to be made, or that enables the processor to keep up with some external process.

As defined herein, the term “responsive to” and similar language as described above, e.g., “if,” “when,” or “upon,” mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

The corresponding structures, materials, acts, and equivalents of all means or step plus function elements that may be found in the claims below are intended to include any structure, material, or act for performing the function in combination with other claimed elements as specifically claimed.

The description of the embodiments provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the embodiments disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

What is claimed is:

1. A computer-implemented method, comprising:
identifying, in response to an inference request, machine learning models available to generate a prediction, wherein the machine learning models identified comprise at least part of an ensemble of machine learning models;
generating an aggregated prediction in response to the inference request, wherein the aggregated prediction aggregates individual predictions generated by machine learning models of the ensemble identified as available to generate a prediction;
responsive to determining that less than all the machine learning models of the ensemble of machine learning models are available, generating a performance guarantee based on the individual predictions generated; and
outputting the aggregated prediction in response to the performance guarantee satisfying a predetermined threshold.

2. The computer-implemented method of claim 1, further comprising training the ensemble of machine learning models, wherein the training comprises:
partitioning training data into a plurality of distinct datasets; and
individually training each machine learning model of the ensemble of machine learning models using one of the plurality of distinct datasets uniquely assigned for training a corresponding one of the machine learning models of the ensemble of machine learning models.

3. The computer-implemented method of claim 2, further comprising updating one or more machine learning models of the ensemble of machine learning models, wherein the updating comprises:
in response to a request to remove specific data samples from the training data, identifying each distinct dataset containing at least some of the specific data samples; and
retraining each machine learning model previously trained using at least some of the specific data samples, wherein the retraining is performed with the distinct datasets from which the specific data samples are excised.

4. The computer-implemented method of claim 1, wherein the inference request is a classification request, and wherein the performance guarantee indicates whether the aggregated prediction is one likely generated based on individual predictions generated by all the machine learning models of the ensemble.

5. The computer-implemented method of claim 1, wherein the inference request is a regression request, and wherein the performance guarantee indicates whether the aggregated prediction is within a predetermined percentage of one generated based on individual predictions generated by all the machine learning models of the ensemble.

6. The computer-implemented method of claim 5, wherein the predetermined percentage corresponds to a tolerance selected by a user.

7. The computer-implemented method of claim 1, wherein a number of distinct datasets and corresponding number of machine learning models are selected to minimize an estimated time to update each of the machine leaning models of the ensemble while maintaining a predetermined level of predication accuracy of aggregated predictions generated by the ensemble.

8. A computer system, comprising:
a processor set;
one or more computer-readable storage media; and
program instructions stored on the one or more computer-readable storage media to cause the processor set to perform operations including:
identifying, in response to an inference request, machine learning models available to generate a prediction, wherein the machine learning models identified comprise at least part of an ensemble of machine learning models;
generating an aggregated prediction in response to the inference request, wherein the aggregated prediction aggregates individual predictions generated by the machine leaning models of the ensemble identified as available to generate a prediction;
responsive to determining that less than all the machine learning models of the ensemble of machine learning models are available, generating a performance guarantee based on the individual predictions generated; and
outputting the aggregated prediction in response to the performance guarantee satisfying a predetermined threshold.

9. The computer system of claim 8, wherein for training the ensemble of machine learning models the operations further include:
partitioning training data into a plurality of distinct datasets; and
individually training each machine learning model of the ensemble of machine learning models using one of the plurality of distinct datasets uniquely assigned for training a corresponding one of the machine learning models of the ensemble of machine learning models.

10. The computer system of claim 9, wherein for updating one or more machine learning models of the ensemble of machine learning models the operations further include:
in response to a request to remove specific data samples from the training data, identifying each distinct dataset containing at least some of the specific data samples; and
retraining each machine learning model previously trained using at least some of the specific data samples, wherein the retraining is performed with the distinct datasets from which the specific data samples are excised.

11. The computer system of claim 8, wherein the inference request is a classification request, and wherein the performance guarantee indicates whether the aggregated prediction is one likely generated based on individual predictions generated by all the machine learning models of the ensemble.

12. The computer system of claim 8, wherein the inference request is a regression request, and wherein the performance guarantee indicates whether the aggregated prediction is within a predetermined percentage of one generated based on individual predictions generated by all the machine learning models of the ensemble.

13. The computer system of claim 12, wherein the predetermined percentage corresponds to a tolerance selected by a user.

14. A computer program product comprising:
one or more computer-readable storage media; and
program instructions stored on the one or more computer-readable storage media to perform operations comprising:
identifying, in response to an inference request, machine learning models available to generate a prediction, wherein the machine learning models identified comprise at least part of an ensemble of machine learning models;
generating an aggregated prediction in response to the inference request, wherein the aggregated prediction aggregates individual predictions generated by the machine leaning models of the ensemble identified as available to generate a prediction;
responsive to determining that less than all the machine learning models of the ensemble of machine learning models are available, generating a performance guarantee based on the individual predictions generated; and
outputting the aggregated prediction in response to the performance guarantee satisfying a predetermined threshold.

15. The computer program product of claim 14, wherein for training the ensemble of machine learning models the operations further include:
partitioning training data into a plurality of distinct datasets; and
individually training each machine learning model of the ensemble of machine learning models using one of the plurality of distinct datasets uniquely assigned for training a corresponding one of the machine learning models of the ensemble of machine learning models.

16. The computer program product of claim 15, wherein for updating the one or more machine learning models of the ensemble the operations further include:
in response to a request to remove specific data samples from the corpus of training data used to the machine learning models of the ensemble, identifying each dataset containing at least some of the specific data samples, wherein the identifying is based on the unique locators assigned each dataset; and
retraining each machine learning model previously trained using at least some of the specific data samples, wherein the retraining is performed with datasets from which the specific data samples are excised.

17. The computer program product of claim 14, wherein the inference request is a classification request, and wherein the performance guarantee indicates whether the aggregated prediction is one likely generated based on individual predictions generated by all the machine learning models of the ensemble.

18. The computer program product of claim 14, wherein the inference request is a regression request, and wherein determining the performance guarantee indicates whether the aggregated prediction is within a predetermined percentage of one generated based on individual predictions generated by all the machine learning models of the ensemble.

19. The computer program product of claim 18, wherein the predetermined percentage corresponds to a tolerance selected by a user.

20. The computer program product of claim 14, wherein a number of distinct datasets and corresponding number of machine learning models are selected to minimize an estimated time to update each of the machine leaning models of the ensemble while maintaining a predetermined level of predication accuracy of aggregated predictions generated by the ensemble.
